(19) United States
(12) Patent Application Publication
(10) Pub. No.: US 2003/0056073 A1
(43) Pub. Date: Mar. 20, 2003

(54) Queue management method and system for a shared memory switch

(75) Inventor: Micha Zeiger, Lod (IL)

Correspondence Address: SUGHRUE, MION, ZINN, MACPEAK & SEAS, PLLC, 2100 Pennsylvania Avenue, N.W., Washington, DC, 20037-3213, US

(73) Assignee: TeraChip, Inc.

(21) Appl. No.: 09/954,006

(22) Filed: Sep. 18, 2001

(51) Int. Cl. G06F 12/10

(52) U.S. Cl. 711/170; 711/203; 711/104

(57) ABSTRACT

A method and system that provides a high processing speed and an efficient memory usage scheme includes multiple logical queues within a single physical memory. For each port of a memory device, a physical memory having slices, a free physical slice address list, and logical queues corresponding to a quality of service (QoS) classes are provided. Each logical queue includes a read pointer and a write pointer, such that a respective read and/or write operation can be performed in accordance with a logical decision that is based on an input. The logical queues manage the physical memory so that reading and writing operations are performed based on availability of free physical slices, as well as QoS. The present invention also manages reading and writing operation when all physical slices in a physical memory are filled, as well as wrap-around and jumping between physical memories.

### BACKGROUND OF THE INVENTION

1. Field of the Invention

The present invention relates to a method and system for creating multiple logical queues within a single physical memory, and more specifically to a method and system of queue allocation in ultra-fast network switching devices, with a large number of output ports, and several priority queues for each port.

2. Background of the Related Art

A related art queue management problem exists for a switching device having M input ports, N output ports, P priorities, RAM storage buffers for B messages, and T memory slices used. A message (i.e., packet or cell) may arrive at the queue manager of a given related art output port on each system clock cycle. For example, messages may arrive from any of the M input ports. The queue manager must be able to store the message descriptor in the appropriate queue within one clock cycle.

A first related art solution to the aforementioned problem includes employing a separate first in, first out-memory (hereinafter referred to as “FIFO”) queue for each priority queue. Since each related art FIFO queue must be pre-allocated to handle the worst-case traffic pattern, each related art FIFO queue must contain B descriptors, where B represents the maximum number of messages residing in the physical message buffer. As a result, a total of B×N×P FIFO entries are required.

Where prioritization is done based on quality of service (QoS), and there are eight priorities (i.e., one for each QoS), data is placed in the queue, and a scheduler takes units of data based on QoS in a weighted round robin (WRR) method. In the first related art method, a queue has a pointer to the address of shared memory (i.e., buffer), where B is the total number of cell units (i.e., addresses). In the first related art method, 8×B cell units are required for each port. For example, for 8 priorities and 16 output ports, 128×B memory addresses would be required, which has the disadvantage of being too much memory space for an ASIC chip to handle. Thus, the first related art method does not provide a memory-efficient solution, and will not fit in one ASIC chip.

Another related art method uses a linked list, to allocate the memory B, where there is no pre-allocation due to varying priorities. A linked list is memory efficient and has a memory size of B, which is an improvement over the 8×B memory size required for the first related art method of the related art solution. The total memory required for the linked list method is 4×B, which is a 50% improvement over the first related art method. However, the linked list method requires significant overhead, and is slower (i.e., about 4 clock cycles for each access).

The related art solutions have various problems and disadvantages. For example, while the first related art solution allows continuous reception and transmission of messages at the maximum rate, it is also very “expensive” in that a large number of descriptors must be pre-allocated for each related art FIFO queue.

The second related art solution involves storing the message descriptor in a linked-list data structure, such as a RAM area common to all queues, and only requires B entries for descriptors, whereas the first related art solution requires B×N×P entries. However, the second related art solution has the disadvantage of being very slow, and is approximately three to four times slower than the first related art solution in message handling rate. Thus, three to four clock cycles are required to process each message in the second related art solution per each clock cycle required for the first related art solution.

Thus, there is a tradeoff between speed and memory use. The first related art method has a high processing speed and a low memory usage, whereas the related art linked list method has a high memory usage and a low processing speed. The related art methods do not include any solution having both a high speed and high memory usage. Further, for large-scale operations, a need exists for such a high-speed, high-memory solution.

### SUMMARY OF THE INVENTION

It is an object of the present invention to provide a method and system for queue management that overcomes at least the various aforementioned problems and disadvantages of the related art.

It is another object of the present invention to provide a method and system having improved processing speed, thus overcoming the delay problems of the related art.

It is yet another object of the present invention to provide a method and system that has an improved memory utilization scheme, and thus minimizes wasted memory space.

To achieve at least the aforementioned objects, a queue management method is provided, comprising writing data to said memory device, said writing comprising (a) determining a status of said memory device, and demanding a new physical slice from a physical slice pool if a current slice is full, (b) extracting a physical slice address from a physical slice address list and receiving said physical slice address in one of a plurality of queues in accordance with said status of said memory device, (c) creating a pointer in said one queue that points to a selected physical memory slice in said physical slice pool, said selected physical memory slice corresponding to said physical slice address, and (d) writing said data to said memory device based on said pointer and repeating said determining, extracting and creating steps until said data has been written to said memory device. The present invention also comprises reading said written data from said memory device, said reading comprising the steps of (a) receiving said written data from said selected physical slice upon which said writing step has been performed, (b) preparing said selected physical slice to receive new data if said selected physical slice is empty, (c) inserting an address of said selected physical slice into said physical slice address list, and (d) removing said pointer corresponding to said selected physical slice from said one queue, wherein said reading step is performed until said written data has been read from said memory device.

Additionally, a queue management system is provided, comprising a physical memory that includes a physical slice pool and a free physical slice address list, and a logical memory that includes a plurality of queues, each of said plurality of queues comprising a read pointer, a write pointer, and a queue having a plurality of locations that store corresponding pointers, wherein each of said corresponding pointers is configured to point to a prescribed physical slice from said physical slice pool.

A means for managing a shared memory switch of a memory device is also provided, comprising a means for physically storing memory that includes a physical slice pool and a free physical slice address list, and a means for logically storing memory that includes a plurality of queues, each of said plurality of queues comprising a read pointer, a write pointer, and a queue having a plurality of locations that store corresponding pointers, wherein each of said corresponding pointers is configured to point to a prescribed physical slice from said physical slice pool.

Further a method of writing data to a memory device is provided, comprising (a) checking a logical pointer of at least one priority queue in response to a write request, (b) determining whether a current memory slice is full, (c) if said current memory slice is full, extracting a new slice address from a physical slice list and updating said logical pointer to a physical address of said new slice address, (d) writing data to said memory device and (e) updating said logical pointer.

Additionally, a method of reading data from a memory device, comprising (a) determining whether a priority queue is empty in response to a read request, and (b) if said priority queue is not empty, performing the steps of (i) translating a logical read pointer to a physical address and reading said physical address, (ii) updating said logical read pointer, and (iii) checking said logical read pointer to determine if a logical slice is empty, wherein a corresponding physical slice is returned to a list of empty physical slices if said logical slice is empty.

### BRIEF DESCRIPTION OF THE DRAWINGS

The accompanying drawings, which are included to provide a further understanding of preferred embodiments of the present invention and are incorporated in and constitute a part of this specification, illustrate embodiments of the invention and together with the description serve to explain the principles of the drawings.

FIG. 1a illustrates a block diagram of the allocation and address translation according to a preferred embodiment of the present invention;

FIG. 1b illustrates the queue handler structure prior to any memory allocation in the preferred embodiment of the present invention;

FIG. 2 illustrates performing a first write to a specific queue according to the preferred embodiment of the present invention;

FIG. 3 illustrates performing a first write to a second queue according to the preferred embodiment of the present invention;

FIG. 4 illustrates extracting additional slices from a free physical slice list according to the preferred embodiment of the present invention;

FIG. 5 illustrates returning a slice to the free physical slice list from a queue according to the preferred embodiment of the present invention;

FIG. 6 illustrates queues and the free physical slice list according to the preferred embodiment of the present invention; and

FIGS. 7a and 7b respectively illustrate a read method and a write method according to the preferred embodiment of the present invention.

### DETAILED DESCRIPTION OF THE INVENTION

Reference will now be made in detail to the preferred embodiment of the present invention, examples of which are illustrated in the accompanying drawings. In the present invention, the terms are meant to have the definition provided in the specification, and are otherwise not limited by the specification.

The present invention provides a method and system for creating multiple logical queues within a single physical memory. The present invention includes a memory block that handles P different queues implemented inside one random access memory (RAM). In the preferred embodiment of the present invention, eight queues are provided. All of the P queues are together dedicated to one output port. In the preferred embodiment of the present invention, the number of output ports equals the number of QoS priority queues, which is 8, but the number of output ports is not limited thereto. Further, physical memory is divided into T slices. In the preferred embodiment of the present invention, the physical memory is divided into 32 slices (0 . . . 31).

In the preferred embodiment of the present invention, an insertion of cell into queue or an extraction of cell from queue can be done at each system clocking signal. A state machine allocates slices of memory in the physical memory as needed, without performing pre-allocation to each queue.

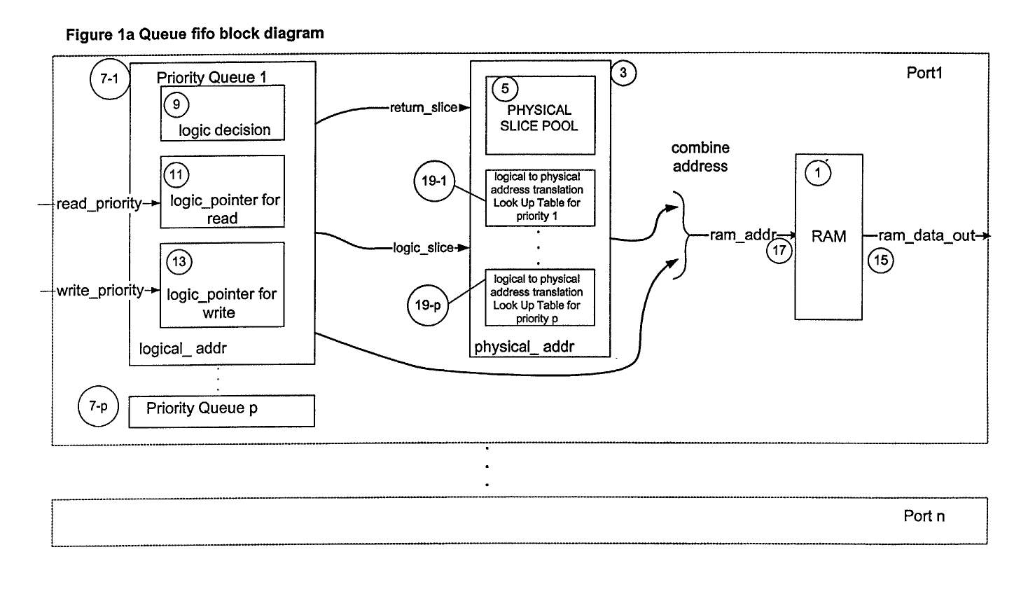

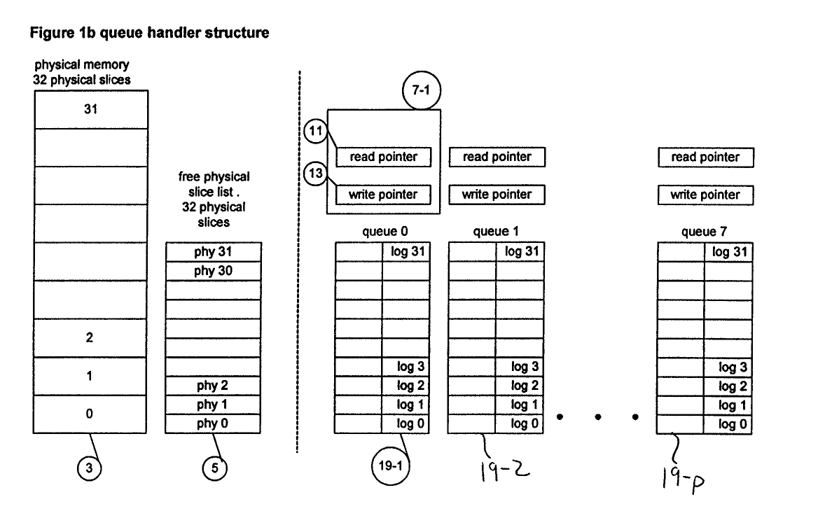

FIG. 1a shows a block diagram of the allocation and address translation system according to the preferred embodiment of the present invention. A random access memory (RAM) 1 is provided having at least one output port 15 and at least one input port 17. Beside the RAM 1, a physical memory 3 that includes a physical slice pool and address translator look up tables (LUT) 19-1, . . . , 19-p is provided, as well as a plurality of queues 7-1, . . . , 7-n. In the preferred embodiment of the present invention, eight queues are provided. However, the number of the queues is not limited to eight. Additionally, port1 . . . portn ports are provided. In each queue (e.g., the first queue 7-1), a logic decision 9, read pointer 11 and write pointer 13 are provided for the queue. The logic decision 9 is made at a point in time when a new slice is extracted or a used slice is returned.

FIG. 1b illustrates the queue handler structure prior to any memory allocation in the preferred embodiment of the present invention. The physical memory 3 is divided into slices of several queue entries. In the preferred embodiment of the present invention, 32 slices are provided, but the present invention is not limited thereto. The physical slice pool 5 has 32 physical slice addresses available (0 . . . 31). Prior to operation of the preferred embodiment of the present invention, the physical slice pool 5 includes pointers to all memory slices. A free physical slice list 5′ provides a list of the free physical memory slices in the physical slice pool 5. The LUT (e.g., 19-1) hold slice addresses for the physical slices that are currently allocated to a queue (e.g., 7-1). Further, each queue 7-1, . . . ,7-n has 32 possible logical sequential slices. When a logical sequential slice is allocated, that logical slice uses LUT 19-1 to be translated to physical memory slices.

In the preferred embodiment of the present invention, extracting begins with the first write operation, and returning is completed after the last read operation.

When data is written into one of the queues (e.g., the first queue 7-1), a logical memory slice is used for that queue 7-1. Logical slices are used sequentially as needed, and are located with the assistance of the LUT (e.g., 19-1). As noted above, each logical queue includes 32 logical slices in the preferred embodiment of the present invention, but is not limited thereto. Similarly, logical slices are freed sequentially after being emptied.

Once the logic decision to write data has been made, each logical slice that is to be used is allocated a physical slice address from the free physical slice list 5′. Once the physical slice is no longer required, the number of that physical slice is returned to the free physical slice list 5′. When writing to a queue, an empty physical (i.e., free) slice is allocated to that queue.

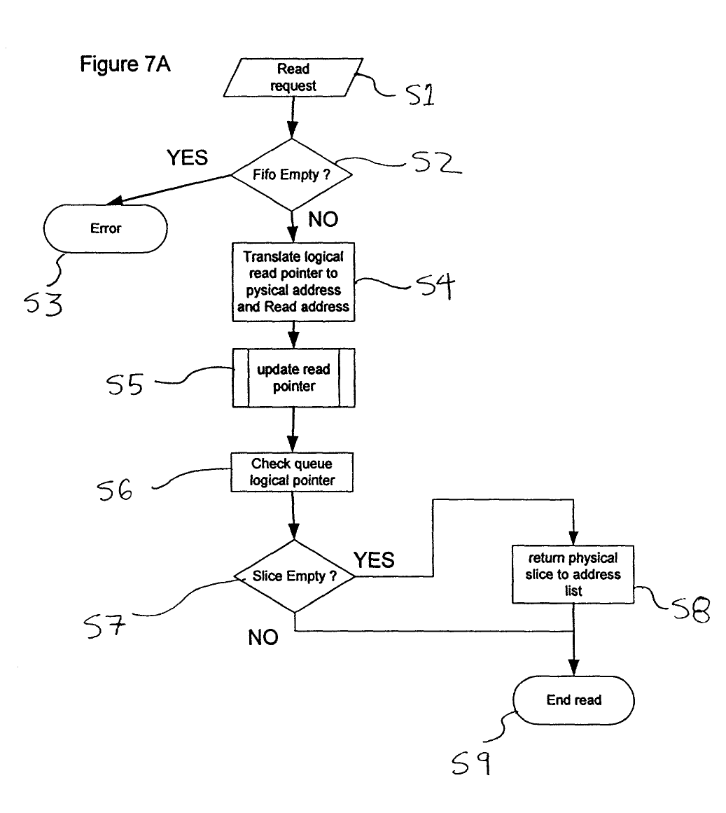

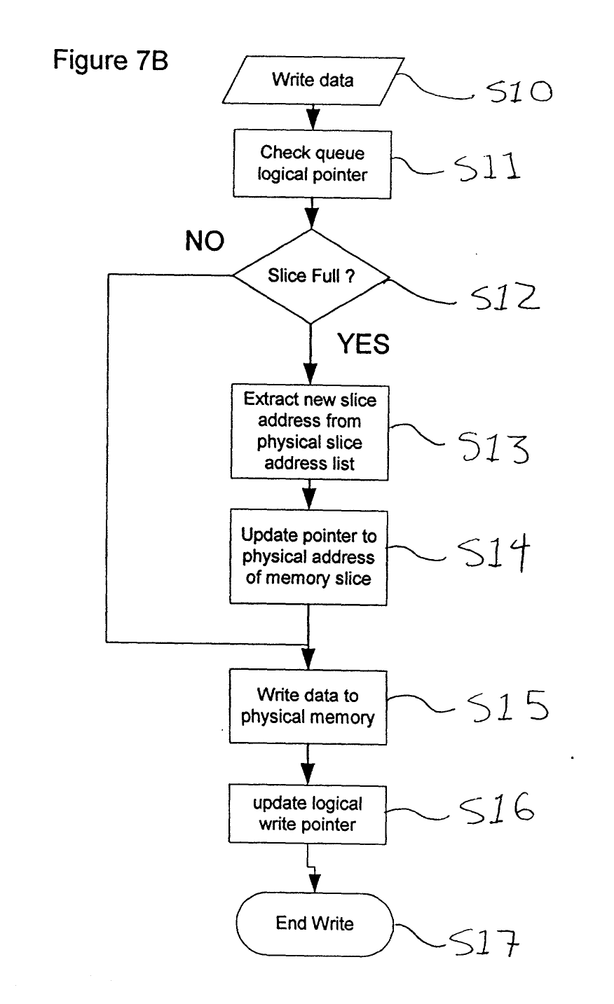

FIGS. 7a and 7b respectively illustrate a read method and a write method according to the preferred embodiment of the present invention. As illustrated in FIG. 7a, a read operation is requested in a first step S1. Then, it is determined whether the FIFO list of the priority queue is empty at step S2. As noted above, each priority queue may correspond to a quality of service (QoS), and thus, the queues may be read in a particular sequence. If the FIFO list of the priority queue is empty, then no read operation can be performed from that priority queue, and it is determined that there is a read error as shown in step S3. If the FIFO list of the priority queue is not empty, then a read operation can be performed by translating a logical read pointer to a physical address and reading the physical address in step S4. Next, the read pointer is updated in step S5, followed by checking the queue logical pointer in step S6.

If the logical slice is found to be empty in step S7, then the corresponding physical slice is returned to the address list at step S8. Thus, the physical slice is indicated to be free. If the slice is not found to be empty in step S7, then step S8 is skipped. The read process is ended at step S9.

Further, a write process may be performed in the present invention, as illustrated in FIG. 7b. At step S10, a write operation is requested, and in step S11, the logical pointer of the priority queue is checked. As noted above, because the priority queues represent QoS, the method can be completed in a particular sequence. At step S12, it is determined whether the slice is full. If the slice is full, then a write operation cannot be performed on the slice, and as shown in step S13, a new slice is extracted from the free physical slice address list. Once the new slice has been extracted in step S13, the pointer to the physical address of the memory slice is updated in step S14. Then, a write operation is performed to physical memory in step S15.

Alternatively, if it is determined at step S12 that the slice is not full, then steps S13 and S14 are skipped, such that step S15 is performed immediately after step S12. As noted above, steps S13 and S14 are skipped because the slice is available. At step S16, the logical write pointer is updated, and the write process ends at step S17.

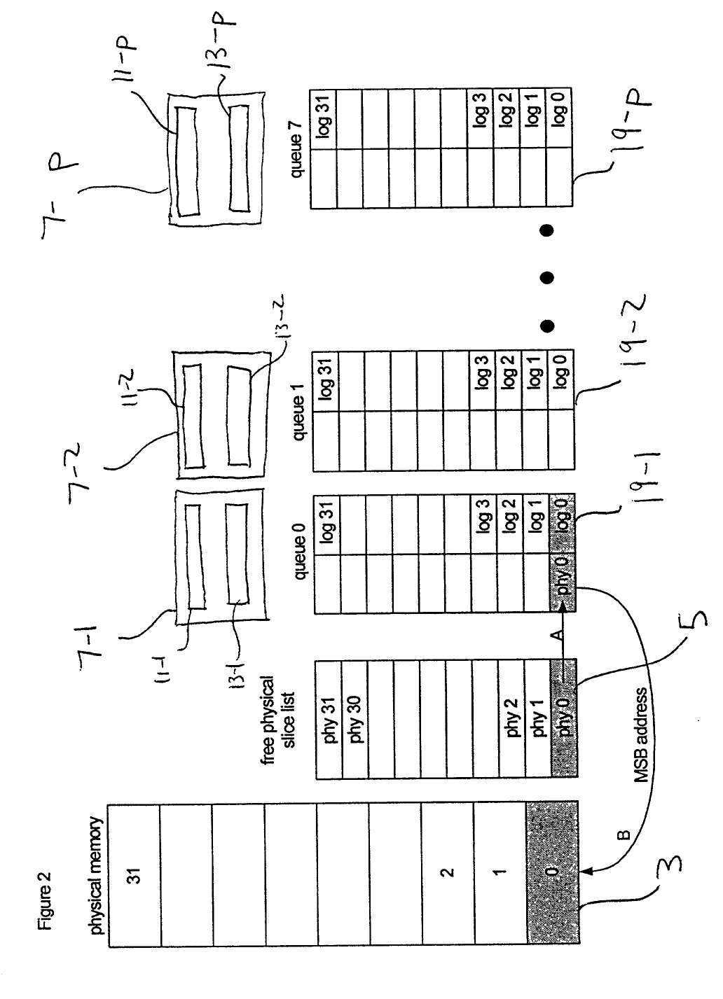

FIG. 2 illustrates an example of performing a first write to a specific queue according to the preferred embodiment of the present invention. A physical slice address phy0 is extracted from free physical slice list 5 (see pointer A) and used in queue 0. As illustrated in FIG. 2, a pointer B in the queue points to the physical slice address 0 in the physical memory 3, where the information is to be written. At this point, all of the other locations in each of the queues (i.e., queue0 . . . queue7) are free of pointers to the physical memory3. The LUTs 19-1...19-p are used in the corresponding queues to locate and translate the physical slice address from the logical address.

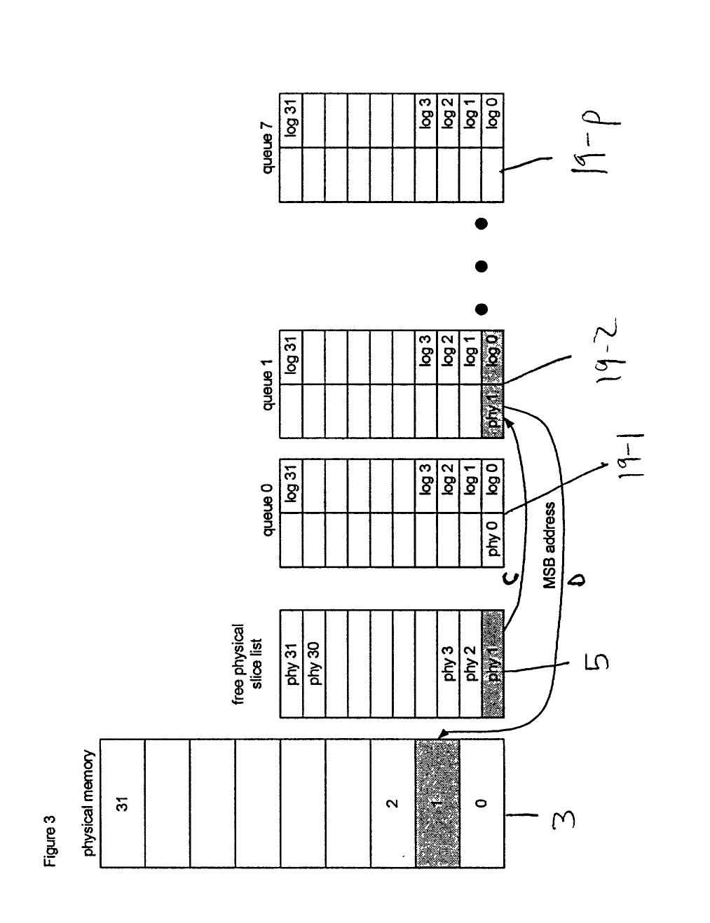

FIG. 3 illustrates performing a first write to a second queue (i.e., queue1) according to the preferred embodiment of the present invention. While priority queues 7-1 . . . 7-p are not illustrated in FIGS. 3-6, the priority queues 7-1 . . . 7-p are included therein in a substantially identical manner as illustrated in FIG. 2, but the queues not illustrated in FIGS. 3-6. As noted above, the first location in the queue phy0 points B to the physical memory slice 0, which has been extracted (i.e., temporarily removed) from free physical slice address list 5. Next, the write operation continues as the next free physical slice address phy1 from the free physical slice address list 5 is extracted, and a pointer C is assigned in the first available position log 0 of the second queue (i.e., queue 1). A pointer D points from physical slice address phy1 of queue1 to the next free physical memory slice 1 in the physical memory 3. The process described above can continue for any of the positions in any of the queues, until the write process has been completed.

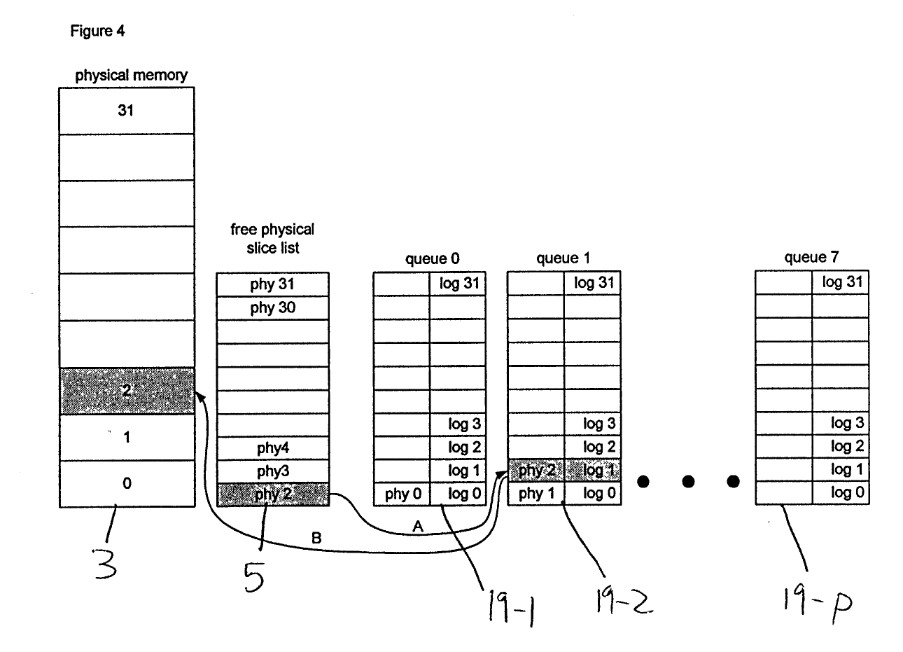

For example, but not by way of limitation, FIG. 4 illustrates extracting additional slices from the free physical slice list 5 according to the preferred embodiment of the present invention. As described above and in FIGS. 2 and 3, write operations have been completed on the first and second physical memory slices phy0, phy1. At this point, a second position log 1 in the second queue (i.e., queue 1) extracts a free physical slice address phy2 from the free physical slice address list 5, as indicated by pointer A. In a manner substantially similar to the method described above, a pointer B at the second position log 1 of the second queue (i.e., queue 1) points to the corresponding physical memory slice 2 of the free physical slice address list 5. After the last write to the current slice, the logical address will be incremented, using a new logical slice and issuing a demand for a new physical slice. A new physical slice address is extracted from the free physical slice address list 5, and loaded as an allocated physical slice address for the current logical slice that points to the physical memory slice to which data is being written.

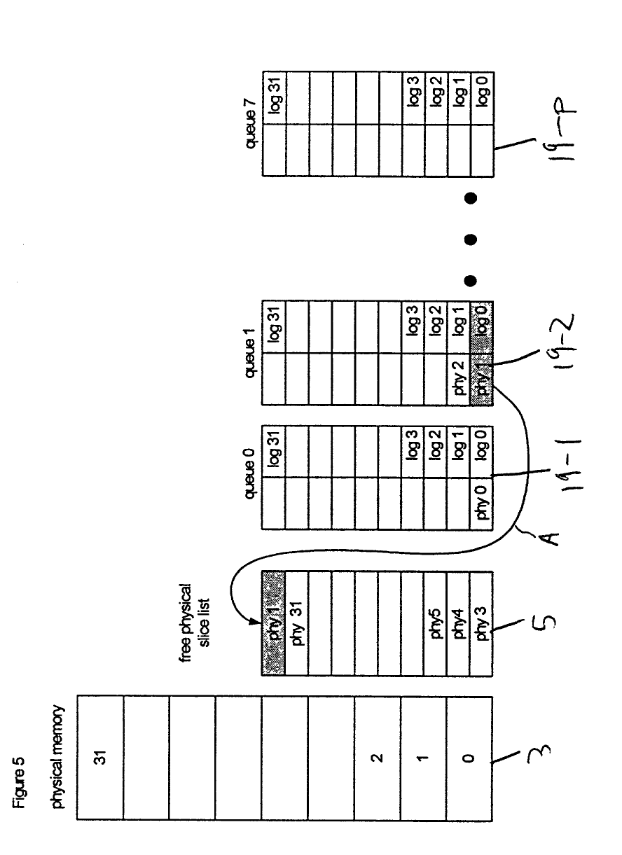

FIG. 5 illustrates returning a slice to the free physical slice list 5 from queue1 according to the preferred embodiment of the present invention. After the last extraction from the current logical slice occurs as described above with reference to FIG. 4, the logical address will increment by one. Then, the next read operation will be performed from a new physical slice that is already allocated to that queue. As illustrated in FIG. 5, if it is determined that the pointer A at the first location log 0 on the second queue (i.e., queue 1) is to be read, that information is read from the physical memory slice 1, and that address of queue1 is added to the free physical slice address list 5 at the end (i.e., phy 1) of the free physical slice list 5. The previous slice (i.e., slice 1 of physical memory 3) is now empty, and the physical address of the emptied slice is returned to the free physical slice list.

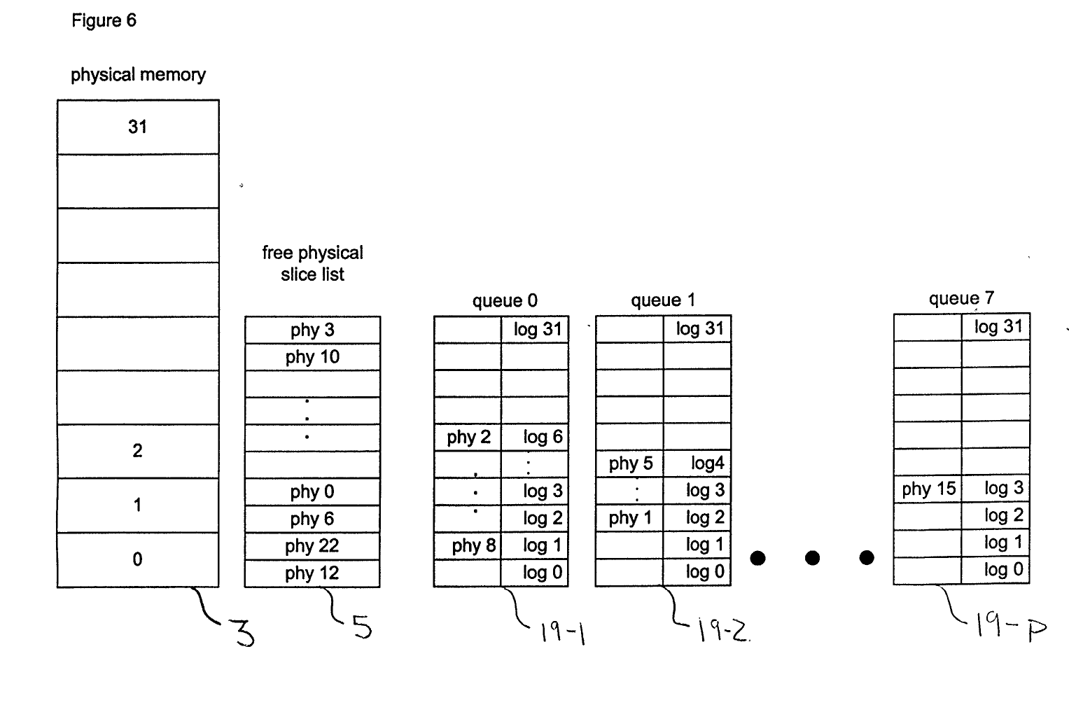

FIG. 6 illustrates queues and the free physical slice list according to the preferred embodiment of the present invention. Here, several iterations of slice extraction and slice insertion have occurred, and the free physical slice address list 5 has been repopulated with slices inserted in the order that they became available. For example, but not by way of limitation, the free physical slice list 5 includes slices of available locations (e.g., phy3) from various different queues, and each of the LUTs 19-1 . . . 19-p include information on which logical slices are available in the respective queues 7-1 . . . 7-n, for use in an upcoming write operation (e.g., phy8 in queue0 corresponding to logical slice log1, phy1 in queue1 corresponding to logical slice log2, and phy 15 in queue7 corresponding to logical slice log 3). Further, various positions in each queues are occupied based on whether a slice has been re-inserted into the free physical slice address list 19.

Additionally, in the preferred embodiment of the present invention, a process known as jumping may be performed, and a jump pointer is stored in a register to facilitate the jumping process, as described in greater detail below. An exemplary description of the process follows, but the process is not limited to the description provided herein. First, locations 0 through 25 of the slice are written, and locations 26 through 31 are thus unoccupied.

Next, in a read process, locations 0 through 10 are read and emptied according to the above-described process. During the next writing step, the next available location is 26, and then, 26 through 31 are written. At this point, locations 11 through 31 are occupied due to the first and second write processes, and locations 0 through 10 have been emptied due to the read process.

In the next write process, locations 0 to 10 will be filled, because location 31 is filled. Thus, the preferred embodiment of the present invention wraps around to the beginning of the slice to continue writing to empty spaces that have been read after the write process has begun.

At this point, all of the locations in the slice are filled. Thus, for the next write, jump must occur to another slice. The location of the last write is kept in a pointer that is owned by a register, such that in the present example, after locations 11 through 31 are read, locations 0 through 10 are then read. Then, the jump pointer, which holds the last write location in slice, points the system to the exact position to stop reading from current slice and continue reading in next slice. Thus, continuity of the aforementioned read and write process can be maintained when the read and write processes are conducted simultaneously on different parts of the slice. Thus, a slice may be partially used, and when fully used, a new slice may be required and used in accordance with the jump pointer.

The present invention has various advantages, and overcomes various problems and disadvantages of the related art. For example, but not by way of limitation, the present invention results in more efficient memory utilization than the related art methods. While the related art system requires, for each port, P * B pointers, (e.g., P is usually 4 or 8), the present invention requires approximately B+(P−1)*(B/T−1) pointers. Thus, the number of required pointers is substantially reduced.

Further, while the related art system has a memory waste of at least (P−1)/P, the “worst case” traffic distribution for the preferred embodiment of the present invention results in a wasted memory space that does not substantially exceed P/T. In the preferred embodiment of the present invention, T is typically approximately 4*P. The present invention also places data in the output port queue within one clock cycle.

Additionally, the preferred embodiment of the present invention has the advantage of providing faster access. The present invention processes messages at the system clock rate, thus overcoming the delay problem of the related art. Further, the preferred embodiment of the present invention will result in cheaper, smaller and feasible ASIC (i.e., 16×16).

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A queue management method, comprising:
writing data to a memory device, said writing comprising,
determining a status of said memory device, and demanding a new physical slice from a physical slice pool if a current slice is full,
extracting a physical slice address from a physical slice address list and receiving said physical slice address in one of a plurality of queues in accordance with said status of said memory device,
creating a pointer in said one queue that points to a selected physical memory slice in said physical slice pool, said selected physical memory slice corresponding to said physical slice address, and
writing said data to said memory device based on said pointer and repeating said determining, extracting and creating steps until said data has been written to said memory device; and
reading said written data from said memory device, said reading comprising the steps of,
receiving said written data from said selected physical slice upon which said writing step has been performed,
preparing said selected physical slice to receive new data if said selected physical slice is empty,
inserting an address of said selected physical slice into said physical slice address list, and
removing said pointer corresponding to said selected physical slice from said one queue,
wherein said reading step is performed until said written data has been read from said memory device.

2. The method of claim 1, further comprising performing said writing step and said reading step on a plurality of queues that are indicative of a corresponding plurality of quality service classes.

3. The method of claim 1, wherein said reading step and said writing step are performed one of simultaneously and sequentially.

4. The method of claim 1, further comprising making a logic decision based on an input signal.

5. The method of claim 1, wherein a read pointer is used to perform said reading step and a write pointer is used to perform said writing step.

6. A queue management system, comprising:
a physical memory that includes a physical slice pool and a free physical slice address list; and
a logical memory that includes a plurality of queues, each of said plurality of queues comprising a read pointer, a write pointer, and a queue having a plurality of locations that store corresponding pointers, wherein each of said corresponding pointers is configured to point to a prescribed physical slice from said physical slice pool.

7. The system of claim 6, wherein a write operation and read operation is performed on said plurality of queues in a sequence indicative of a corresponding plurality of quality service classes.

8. The system of claim 7, wherein said read operation and said write operation are one of simultaneous and sequential.

9. The system of claim 6, further comprising an input signal that is used to make a logic decision.

10. The system of claim 6, wherein said logical memory and said physical memory are in respective random access memory (RAM) devices.

11. The system of claim 6, wherein said plurality of queues comprises 8 queues, said physical slice pool comprises 32 physical slices, said corresponding pointers comprises 32 pointers per queue, and 32 possible entries are permitted per slice.

12. A means for managing a shared memory switch of a memory device, comprising:
a means for physically storing memory that includes a physical slice pool and a free physical slice address list; and
a means for logically storing memory that includes a plurality of queues, each of said plurality of queues comprising a read pointer, a write pointer, and a queue having a plurality of locations that store corresponding pointers, wherein each of said corresponding pointers is configured to point to a prescribed physical slice from said physical slice pool.

13. A method of writing data to a memory device, comprising:
checking a logical pointer of at least one priority queue in response to a write request;
determining whether a current memory slice is full;
if said current memory slice is full, extracting a new slice address from a physical slice list and updating said logical pointer to a physical address of said new slice address;
writing data to said memory device; and
updating said logical pointer.

14. The method of claim 13, wherein said at least one priority queue represents at least one quality of service class.

15. The method of claim 14, wherein said method is performed said at least one queue in accordance with an order of said at least one quality of service class.

16. A method of reading data from a memory device, comprising:
determining whether a priority queue is empty in response to a read request;
if said priority queue is not empty, performing the steps of,
translating a logical read pointer to a physical address and reading said physical address,
updating said logical read pointer, and
checking said logical read pointer to determine if a logical slice is empty, wherein a corresponding physical slice is returned to a list of empty physical slices if said logical slice is empty.

17. The method of claim 16, wherein said priority queue represents a quality of service class.

18. The method of claim 17, wherein said method is performed said queue in accordance with an order of said quality of service class.

19. The method of claim 16, further comprising generating an error message if said priority queue is empty.
